(19) United States
(12) Patent Application Publication
(10) Pub. No.: US 2014/0071867 A1
(43) Pub. Date: Mar. 13, 2014

(54) PORTABLE ROUTING DEVICE AND THE POWER SAVING METHOD THEREOF

(71) Applicant: Hung-Yao YEH, Taipei City (TW)

(72) Inventor: Hung-Yao YEH, Taipei City (TW)

(21) Appl. No.: 13/778,477

(22) Filed: Feb. 27, 2013

(30) Foreign Application Priority Data
Mar. 5, 2012 (TW) 101107309

(51) Int. Cl. H04W 52/02; H04W 76/02

(52) U.S. Cl. CPC H04W 52/0206; H04W 76/02
USPC 370/311

(57) ABSTRACT

The present invention is utilized in a space having a first network terminal and a second network terminal therein. The portable routing device comprises a routing module and a controlling module. The routing module is utilized to connect to the first network terminal so as to share the first network terminal with at least one electronic device. The controlling module is utilized to determine the priority of the first and the second network terminals respectively in accordance with a predetermined factor and stop sharing the first network terminal to the electronic device once the priority of the second network terminal is higher than the first network terminal. By avoiding the unnecessary routing action, the present invention is capable of saving power without affecting the normal use of the user.

### PRIORITY CLAIM

This application claims the benefit of the filing date of Taiwan Patent Application No. 101107309, filed Mar. 5, 2012, entitled “PORTABLE ROUTING DEVICE AND THE POWER SAVING METHOD THEREOF,” and the contents of which is hereby incorporated by reference in its entirety.

### Field of the Invention

The present invention relates to a portable routing device and the power saving method thereof and more particularly to a portable routing device having a first energy-saving mode and a second energy-saving mode, and a corresponding power saving method thereof.

### BACKGROUND OF THE INVENTION

Router is a kind of network equipment for connecting computer networks to one another, used for handling the routing of packets between two networks; wherein, wireless routers are used to build local wireless networks that communicate with each other without using physical wires. Therefore, wireless routers can be connected to the electronic devices which have wireless data transmission function via Wi-Fi or other wireless transmission technologies. However, considering the convenience for using, a lightweight design has been an important factor in the development of the portable wireless routers.

In convention, the portable wireless router only integrated wireless router and cellular data interface; nowadays, with the development of the technology, the portable routing device can be compressed and integrated into mobile phones or other electronic products, so as to provide routing function for other electronic devices which have the wireless transmission function. However, in order to remain transmitting data, the conventional portable routing device provides the routing function continuously no matter the electronic device is in idle state or usage state, causing the extra energy consumption.

Accordingly, how to develop a portable routing device which is capable of saving power without affecting the normal use of the user is the primary topic in this field.

### SUMMARY OF THE INVENTION

Therefore, in order to improve the problem described previously, an aspect of the present invention is to provide a portable routing device utilized in a space having a first network (access) terminal and a second network (access) terminal. The portable routing device comprises a routing module and a controlling module, wherein the routing module is connected to the first network terminal for sharing the first network terminal with at least one electronic device, and the controlling module is coupled with the routing module for determining a priority of the first network terminal and the second network terminal respectively in accordance with a predetermined factor; that is to say, when the priority of the second network terminal is higher than the priority of the first network terminal, the controlling module controls the routing module to stop sharing the first network terminal with the electronic device and in turn makes the electronic device to connect to the second network terminal as a replacement.

More specifically, the routing module is connected to the first network terminal to build a third network (access) terminal for sharing the first network terminal with at least one electronic device, and the controlling module is coupled with the routing module for determining a priority of the second network terminal and the third network terminal respectively in accordance with a predetermined factor; when the priority of the second network terminal is higher than the priority of the third network terminal, the controlling module controls the routing module to turn off the third network terminal.

In actual application, after turning off the third network terminal, the controlling module continues to detect whether the second network terminal is available; if not, the controlling module controls the routing module to rebuild the third network terminal for allowing the electronic device to access the first network terminal. Additionally, the predetermined factor comprises a sequence list set by users, and the sequence list stores the priority of the second network terminal and the third network terminal.

To be noticed, the communication formats of the first network terminal and the second network terminal are different, and the third network terminal has a communication format the same as the communication format of the second network terminal; wherein the first network terminal and the second network terminal adopt a communication format corresponding to Mobile Data Network (e.g., LTE protocol) or Wireless Local Area Network (e.g., IEEE 802.11 standard). Furthermore, the Wireless Local Area Network can be replaced by Wireless Personal Area Network (e.g., Bluetooth).

The portable routing device of the invention can further comprise a power-sensing module, used for monitoring a dump energy and preventing an unauthorized user from accessing the first network terminal through the third network terminal when the dump energy is below a threshold value.

Another aspect of the present invention is to provide a power saving method for a portable routing device; this method generally comprises three steps: S1 to S3. Step S1 is to determine whether a priority of the second network terminal is higher than the third network terminal in accordance with a predetermined factor, if yes, proceeding to step S2. Step S2 is to turn off the third network terminal so as to connect the electronic device to the second network terminal as a replacement. And, step S3 is continuing to detect whether the second network terminal is available; if not, rebuilding the third network terminal. To be noticed, the detailed description of the portable routing device is in essence the same with the portable routing device described above, thus it needs not to be elaborated here.

Besides, another aspect of the present invention discloses another portable routing device, coupled with a first network terminal for building a third network terminal; and the third network terminal allows an electronic device to access the first network terminal. Furthermore, this portable routing device comprises a statistical module and a judgment module. The statistical module is used for counting a duration time, wherein the duration time is a time span when the network traffic per unit time between the electronic device and the third network terminal is below a threshold value; and, the judgment module is used for performing a corresponding controlling action in accordance with a predetermined factor.

In actual application, when the predetermined factor is the duration time above a first threshold value, the corresponding controlling action is to interrupt the data transmission between the portable routing device and the first network terminal. When the predetermined factor is the duration time above a second threshold value, the corresponding controlling action is to turn off the third network terminal. Moreover, when the predetermined factor is the duration time above a second threshold value, the corresponding controlling action is to switch the portable routing device into a standby mode, indicating the relationship among the portable routing device, the first network terminal, and the electronic device is mutual independence without data transmission. To be noticed, the term “data” mentioned above only means the required information bits for building the third network terminal or the routing internet; that is to say, if the portable routing device is a cell phone, the mobile communication signals and data can still be transmitted and received for the cell phone's use.

In addition, another aspect of the present invention discloses a power saving method for a portable routing device; this method generally comprises two steps: R1 and R2. Step R1 is to count a duration time, wherein the duration time is a time span when the network traffic per unit time between the electronic device and the third network terminal is below a threshold value; and step R2 is performing a corresponding controlling action in accordance with a predetermined factor. The detailed description of the portable routing device is in essence the same with the portable routing device described above, thus it needs not to be elaborated here.

According to the embodiments described above, the invention discloses a portable routing device having a first energy-saving mode and a second energy-saving mode. The operating principle of the energy-saving mode is substituting the other available network terminals for the routing function of the portable routing device according to user's settings. And, the second energy-saving mode utilizes multilayer network surveillance to reduce any unnecessary routing, so as to save energy.

Many other advantages and features of the present invention will be further understood by the detailed description and the accompanying sheet of drawings.

### BRIEF DESCRIPTION OF THE DRAWINGS

FIG. 1 is a functional block diagram illustrating a portable routing device according to an embodiment of the invention.

FIG. 2A is a schematic diagram illustrating the first energy-saving mode of the portable routing device is turned on at the first moment according to the invention.

FIG. 2B is a schematic diagram illustrating the first energy-saving mode of the portable routing device is turned on at the second moment according to the invention.

FIG. 2C is a schematic diagram illustrating the first energy-saving mode of the portable routing device is turned on at the third moment according to the invention.

FIG. 3A is a schematic diagram illustrating the second energy-saving mode of the portable routing device is turned on at the fourth moment according to the invention.

FIG. 3B is a schematic diagram illustrating the second energy-saving mode of the portable routing device is turned on at the fifth moment according to the invention.

FIG. 3C is a schematic diagram illustrating the second energy-saving mode of the portable routing device is turned on at the sixth moment according to the invention.

FIG. 4 is a flowchart illustrating a power saving method for the portable routing device according to an embodiment of the invention.

FIG. 5 is a flowchart illustrating a power saving method for the portable routing device according to an embodiment of the invention.

To facilitate understanding, identical reference numerals have been used, where possible to designate identical elements that are common to the figures.

### DETAILED DESCRIPTION

The invention discloses a portable routing device for sharing the first network (access) terminal with at least one electronic device, wherein the portable routing device having a first energy-saving mode and a second energy-saving mode. To be noticed, the term “terminal” mentioned herein represents the network access service available in the space.

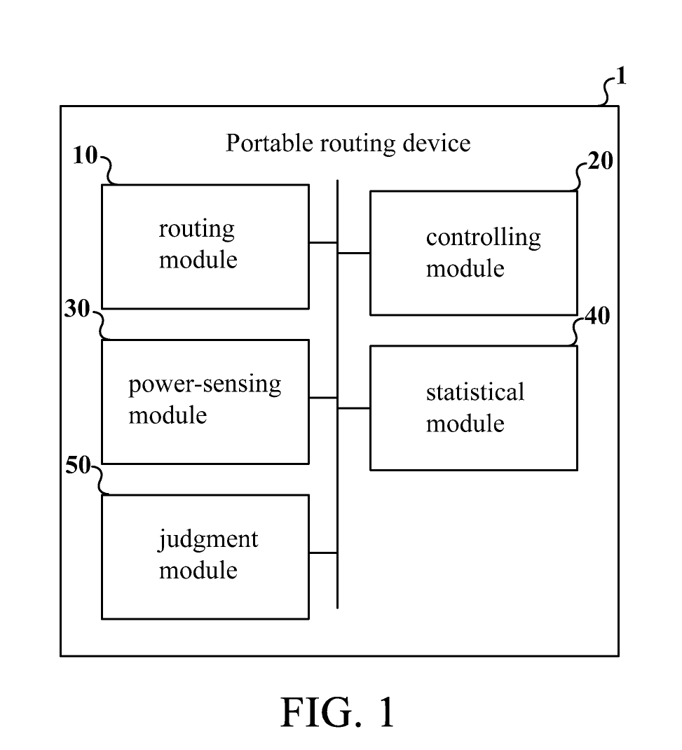

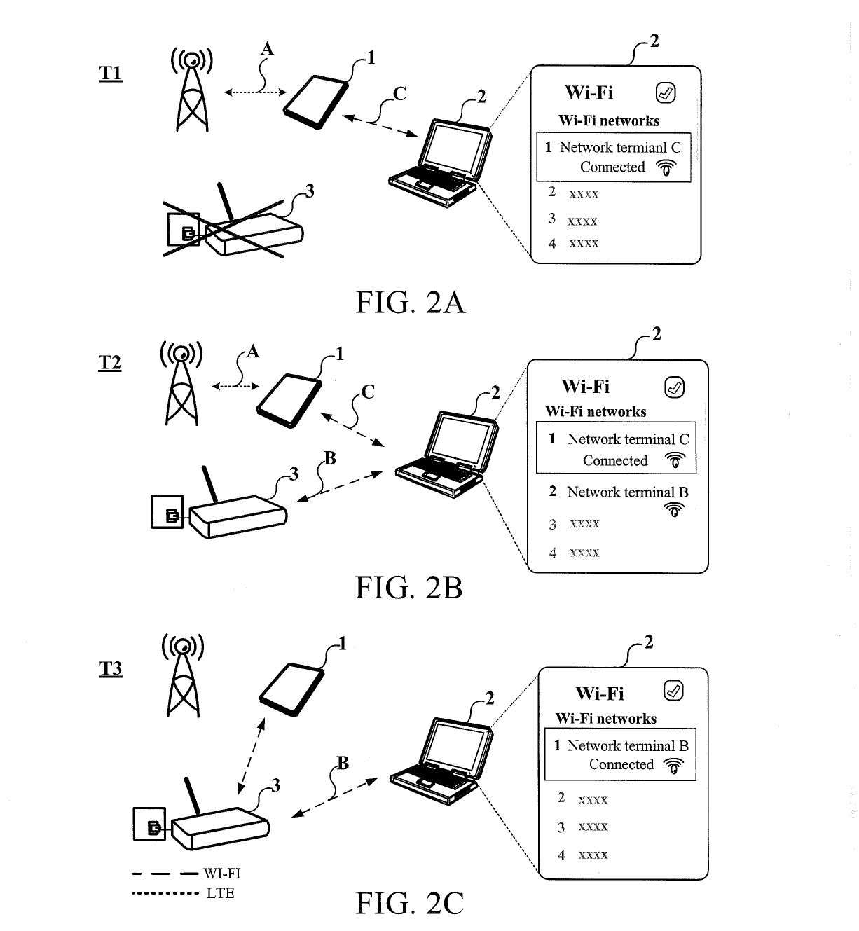

Please refer to FIG. 1 and FIG. 2A to 2C. FIG. 1 is a functional block diagram illustrating a portable routing device according to an embodiment of the invention. FIG. 2A to 2C are the schematic diagrams illustrating the first energy-saving mode of the portable routing device is turned on at the first, the second, and the third moment respectively according to the invention. The portable routing device 1 of the invention comprises a routing module 10 and a controlling module 20. When the first energy-saving mode is turned on, the routing module 10 may access and share the first network terminal A with at least one electronic device 2; and meanwhile, the controlling module 20 coupled with the routing module 10 may determine a priority of the first network terminal A and the second network terminal B respectively in accordance with a predetermined factor. That is to say, if the priority of the second network terminal B is higher than the priority of the first network terminal A, the controlling module 20 may control the routing module 10 to stop sharing the first network terminal A with the electronic device and connect to the second network terminal B as a replacement.

More specifically, the routing module 10 is coupled and connected to the first network terminal A to build a third network terminal C correspondingly. The third network terminal C allows an electronic device 2 to access the first network terminal A. Furthermore, the controlling module 20 may determine a priority of the second network terminal B and the third network terminal C respectively in accordance with a predetermined factor; therefore, when the priority of the second network terminal B is higher than the priority of the third network terminal C, the controlling module 20 may control the routing module 10 to turn off the third network terminal C, wherein the predetermined factor comprises a sequence list which is set by users. Additionally, the priority of the second network terminal B and the third network terminal C can be stored in the sequence list. After turning off the third network terminal C, the controlling module 20 may continue to detect whether the second network terminal B is available; if not, the controlling module 20 controls the routing module 10 to rebuild the third network terminal C for allowing the electronic device 2 to access the first network terminal A.

The definitions of the terms mentioned above are illustrated as following descriptions. The space generally refers to the application environment of the invention. The first network terminal A generally means the network providers which can perform data transmission with the portable routing device 1 of the invention, or means the wireless network signals generated by the equipments of network providers; the third network terminal C generalizes for the wireless local area network (wireless routing network) of the portable routing device 1; and the second network terminal B represents another network provider excluding the first network terminal A and the third network terminal C, or represents the wireless network signal thereof.

In the embodiment, the first network terminal A adopts a communication format of Mobile Data Network (e.g., LTE protocol); the second network terminal B and the third network terminal C adopt a communication format corresponding to IEEE 802.11-based wireless local area network (e.g., Wi-Fi) and its variations, including peer-o-peer, thereof. To be noticed, the first network terminal A, the second network terminal B, and the third network terminal C are not limited to the description above, they may adopt various network communication protocols including WIMAX, GPRS, EDGE, WCDMA, EVDO, TD-SCDMA, HS(D/U)PA, HSPA+, LTE or other Wireless Wide Area Network (WWAN), or other Wireless Personal Area Network, e.g., Bluetooth, ZigBee, UWB, HomeRF. Besides, the first network terminal A and the second network terminal B are connected to a network system respectively; in this embodiment, the network system is an internet, but it is not limited to this, the network system may be an intranet.

Moreover, the portable routing device 1 of the invention is used for providing a routing function to establish a local area network (LAN) allowing other electronic devices 2 to access another network terminal; wherein the portable routing device 1 of the invention generally refers to the electronic devices having independent power supply and routing function such as mobile smart phone or portable computer; the local area network mentioned above may be a wireless network or a cable network; and the electronic devices 2 generalizes the devices which can perform network access to the portable routing device 1 such as cell phone, computer or other wireless networking devices. In the embodiment, the second network terminal B is generated from an indoor wireless router.

Additionally, the predetermined factor mentioned above generally refers to the information used for determining the priority of each network terminal. The predetermined factor comprises a sequence list storing the priority of the second network terminal B and the third network terminal C. Therefore, users can directly set the sequencing of each network terminal. Besides, the predetermined factor may further comprise the data such as signal strength, signal categories, time span of connection and disconnection. Furthermore, turning the network terminal off means terminating the network connection between the third network terminal C and the electronic device 2, thus the routing device may not be detected by the electronic device 2.

Subsequently, please refer to FIG. 2A to 2C again. As shown in FIG. 2A, when the first energy-saving mode of the portable routing device 1 is turned on at the first moment T1, the users can enable the electronic device 2 to access the first network terminal A via the third network terminal C generated from the portable routing device 1, and meanwhile, the second network terminal B is not available; therefore, the available network list of electronic device 2 may display the third network terminal C for connecting conveniently.

As shown in FIG. 2B, at the second moment T2, the second network terminal B may be turned on and detected by the electronic device 2; therefore, the second network terminal B and the third network terminal C may be displayed in the available network list of electronic device 2.

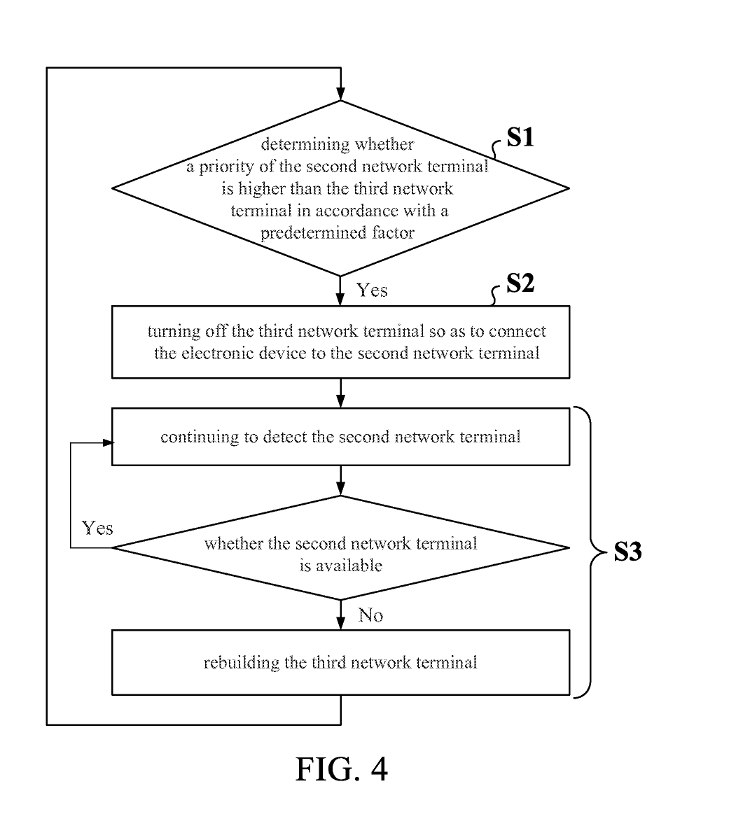

Please refer to FIG. 2C, at the third moment T3, the second network terminal B is detected by the controlling module 20 of the portable routing device 1, and then the controlling module 20 may determine whether the priority of the second network terminal B is higher than the third network terminal C in accordance with a predetermined factor; if yes, the controlling module 20 may control the routing module 10 to turn off the third network terminal C and interrupt the coupling between the portable routing device 1 and the first network terminal A. As shown in FIG. 2C, after turning the third network terminal C off, the available network list of electronic device 2 only displays the second network terminal B; and the electronic device 2 may automatically access and connect to the second network terminal B as a replacement. Meanwhile, the portable routing device 1 can also be coupled with the second network terminal B from the indoor wireless router 3, so as to detect and monitor the second network terminal B uninterruptedly; however, when the second network terminal B is un-accessible, the routing module 10 of the routing device 1 may access and connect with the first network terminal A automatically and rebuild a third network terminal C (routing network) to return to the status of the first moment T1, so as to reconnect with the electronic device 2. Accordingly, by substituting the other available network terminals for the routing function of the portable routing device 1, the invention can achieve the object of energy saving. Furthermore, please refer to FIG. 4. FIG. 4 is a flowchart illustrating a power saving method for the portable routing device according to an embodiment of the invention. Considering the steps S1 to S3 correspond to the description of FIG. 2A to 2C, the steps of FIG. 4 need not to be elaborated further.

Additionally, the portable routing device 1 of the invention may further comprise a power-sensing module 30. The power-sensing module 30 is utilized for monitoring a dump energy and preventing an unauthorized user from accessing the first network terminal A through the third network terminal C when the dump energy is below a threshold value. In brief, when the dump energy is below a threshold value, the portable routing device 1 may identify whether the electronic device 2 is an authorized user or not according to an authorization list predetermined by user; and then, the unauthorized user can not have the access permission of the first network terminal A, so as to control the data traffic and save energy.

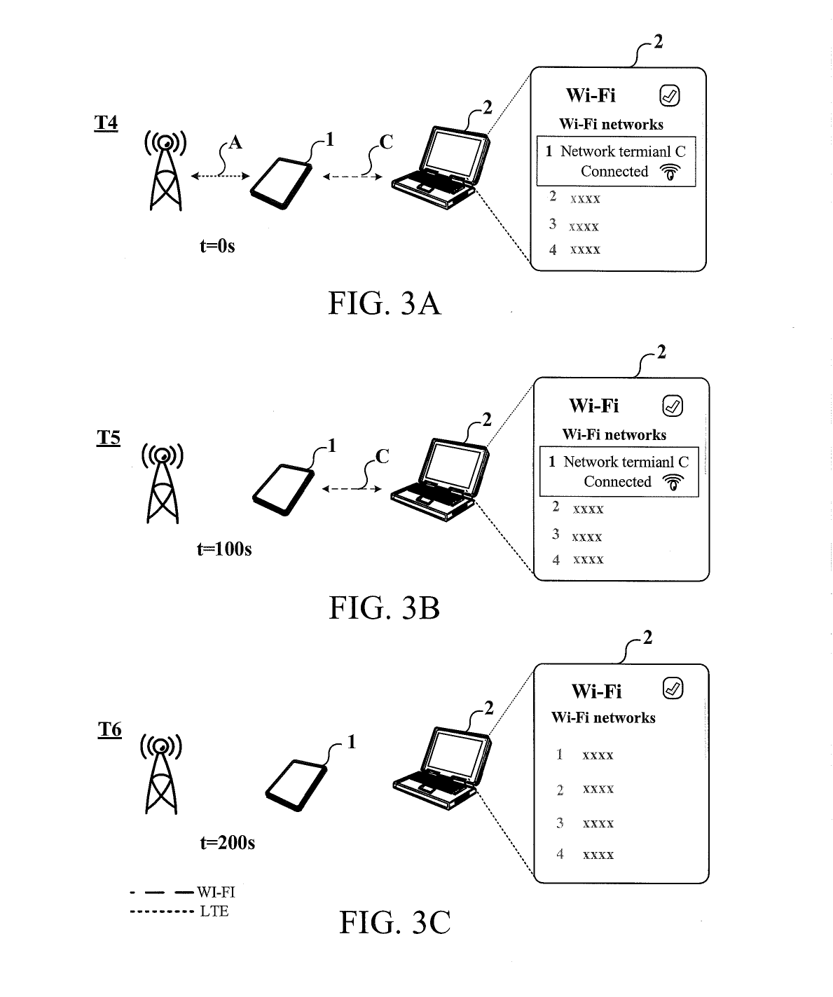

Subsequently, please refer to FIG. 1 and FIG. 3A to 3C. FIG. 3A to 3C are the schematic diagrams illustrating the second energy-saving mode of the portable routing device is turned on at the fourth, the fifth, and the sixth moment respectively according to the invention. The portable routing device 1 of the invention comprises a routing module 10, a statistical module 40, and a judgment module 50. When the second energy-saving mode is turned on, the routing module 10 may build a third network terminal C for sharing the first network terminal A with at least one electronic device 2. The statistical module 40 is used for counting a duration time, wherein the duration time is a time span when the network traffic per unit time between the electronic device 2 and the third network terminal C is below a threshold value; and, the judgment module 50 is used for performing a corresponding controlling action in accordance with a predetermined factor. To be noticed, the predetermined factor and the controlling action mentioned above comprise the following conditions. The first condition is when the predetermined factor is a duration time above a first threshold value, the corresponding controlling action is to interrupt the data transmission between the portable routing device 1 and the first network terminal A. The second condition is when the predetermined factor is the duration time above a second threshold value, the corresponding controlling action is to turn off the third network terminal C or switch the portable routing device 1 into a standby mode; wherein when the portable routing device 1 is in the standby mode, the portable routing device 1 can still have a signal connection with the first network terminal A, and meanwhile, the portable routing device 1, the first network terminal A, and the electronic device 2 are mutual independence without data transmission.

To be more precise, the duration time mentioned above is a time span when the network traffic per unit time between the electronic device 2 and the third network terminal C is below a threshold value; the threshold value is a network traffic value measured in bits; and, the first threshold value and the second threshold value represent a time span in seconds respectively. To be noticed, the threshold value, the first threshold value and the second threshold value are predetermined by users. For example, assuming the threshold value is 10 kilobits (Kb), when the packets transmitted from the electronic device 2 is less than 10 Kb within the unit time of 100 seconds, the statistical module 40 of the portable device 1 may start to count a duration time; and then, if the duration time is larger than the first threshold value, the judgment module 50 may judge the condition is satisfied and further to perform a corresponding controlling action.

Please refer to FIG. 3A to 3C again. As shown in FIG. 3A, at the fourth moment, the user can use the electronic device 2 to access the first network terminal A via the third network terminal C generated from the invention; to be noticed, the network traffic between the electronic device 2 and the portable routing device 1 almost approaches to zero at the fourth moment.

As shown in FIG. 3B, at the fifth moment T5, the network traffic per unit time between the electronic device 2 and the portable routing device 1 is below a threshold value, and the duration time is achieved a first threshold value. In the embodiment, the first threshold value is about 100 seconds; when the predetermined factor is the duration time above a first threshold value, the corresponding controlling action is to interrupt the data transmission between the portable routing device 1 and the first network terminal A.

As shown in FIG. 3C, at the sixth moment T6, the duration time is achieved a second threshold value, in this embodiment, the second threshold value is 200 seconds; and meanwhile, the third network terminal C is turned off so as to interrupt the data transmission between the portable routing device 1 and the electronic device 2. Therefore, the third network terminal C may not be displayed within the available network list of electronic device 2. Furthermore, the portable routing device 1 may be switched into a standby mode, indicating the relationship among the portable routing device 1, the first network terminal A, and the electronic device 2 is mutual independence without data transmission; thus, the invention can save electricity in this manner.

More specifically, if the portable routing device 1 is a cell phone, the user should predetermine a first threshold value and a second threshold value. When the predetermined factor is the duration time above a first threshold value, the corresponding controlling action is to interrupt the data transmission between the portable routing device 1 and the first network terminal A. Moreover, when the predetermined factor is the duration time above a second threshold value, the third network terminal C is turned off and the routing function of the cell phone may be disabled automatically.

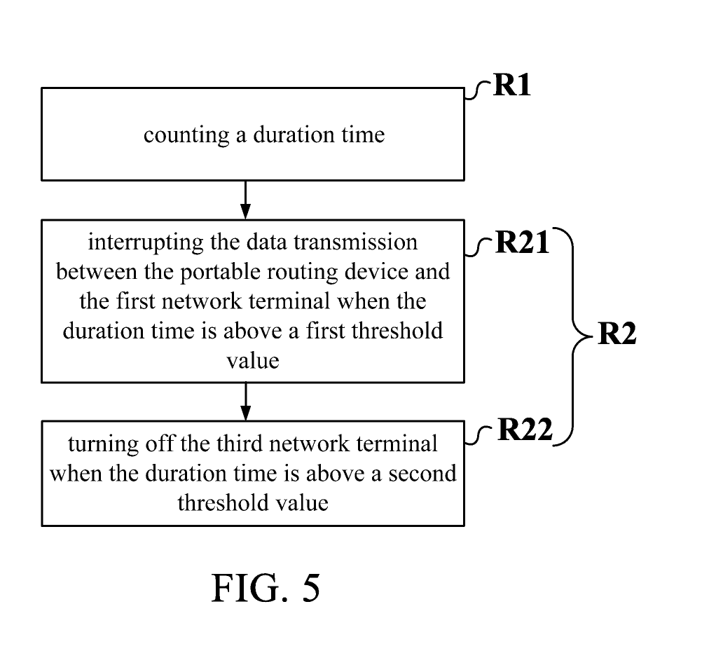

Please refer to FIG. 5 at the same time. FIG. 5 is a flowchart illustrating a power saving method for the portable routing device according to an embodiment of the invention. Considering the steps R1, R2, R21, and R22 correspond to the description of FIG. 3A to 3C, the steps of FIG. 5 need not to be elaborated further.

According to the embodiments described above, the invention discloses a portable routing device having a first energy-saving mode and a second energy-saving mode. The operating principle of the energy-saving mode is substituting the other available network terminals for the routing function of the portable routing device according to user's settings. And, the second energy-saving mode utilizes multilayer network surveillance to reduce any unnecessary routing, so as to save energy.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A portable routing device, utilized in a space having a first network terminal and a second network terminal, comprising:
a routing module, connected to the first network terminal, for sharing the first network terminal with at least one electronic device; and
a controlling module, coupled with the routing module, for determining a priority of the first network terminal and the second network terminal respectively in accordance with a predetermined factor;
wherein when the priority of the second network terminal is higher than the priority of the first network terminal, the controlling module controls the routing module to stop sharing the first network terminal with the electronic device and connect to the second network terminal as a replacement.

2. A portable routing device, utilized in a space having a first network terminal and a second network terminal, comprising:
a routing module, connected to the first network terminal to build a third network terminal for sharing the first network terminal with at least one electronic device; and
a controlling module, coupled with the routing module, for determining a priority of the second network terminal and the third network terminal respectively in accordance with a predetermined factor;
wherein when the priority of the second network terminal is higher than the priority of the third network terminal, the controlling module controls the routing module to turn off the third network terminal.

3. The portable routing device of claim 2, wherein after turning off the third network terminal, the controlling module continues to detect whether the second network terminal is available; if not, the controlling module controls the routing module to rebuild the third network terminal for allowing the electronic device to access the first network terminal.

4. The portable routing device of claim 2, wherein the availability of the second network terminal is detected by the controlling module or reported by the electronic device.

5. The portable routing device of claim 2, wherein the predetermined factor is set by users.

6. The portable routing device of claim 2, wherein the predetermined factor comprises a sequence list set by users, which stores the priority of the second network terminal and the third network terminal.

7. The portable routing device of claim 2, wherein the first network terminal, the second network terminal, and the third network terminal adopt a communication format corresponding to Mobile Data Network or Wireless Local Area Network.

8. The portable routing device of claim 2, further comprising a power-sensing module, for monitoring a dump energy and preventing an unauthorized user from accessing the first network terminal through the third network terminal when the dump energy is below a threshold value.

9. A power saving method for a portable routing device, utilized in a space having a first network terminal, a second network terminal, and a third network terminal for allowing an electronic device to access the first network terminal, the method comprising the following steps of:
S1: determining whether a priority of the second network terminal is higher than the third network terminal in accordance with a predetermined factor, if yes, proceeding to step S2; and
S2: turning off the third network terminal so as to connect the electronic device to the second network terminal as a replacement.

10. The power saving method of claim 9, further comprising the following step of:
S3: continuing to detect whether the second network terminal is available; if not, rebuilding the third network terminal.

11. The power saving method of claim 9, wherein the predetermined factor is set by users.

12. The power saving method of claim 9, wherein the first network terminal and the second network terminal adopt a communication format corresponding to Mobile Data Network or Wireless Local Area Network.

13. A portable routing device, coupled with a first network terminal for building a third network terminal which allows an electronic device to access the first network terminal, comprising:
a statistical module, used for counting a duration time; and
a judgment module, used for performing a corresponding controlling action in accordance with a predetermined factor;
wherein the duration time is a time span when the network traffic per unit time between the electronic device and the third network terminal is below a threshold value.

14. The portable routing device of claim 13, wherein when the predetermined factor is the duration time above a first threshold value, the corresponding controlling action is to interrupt the data transmission between the portable routing device and the first network terminal.

15. The portable routing device of claim 13, wherein when the predetermined factor is the duration time above a second threshold value, the corresponding controlling action is to turn off the third network terminal.

16. The portable routing device of claim 13, wherein when the predetermined factor is the duration time above a second threshold value, the corresponding controlling action is to switch the portable routing device into a standby mode, indicating the relationship among the portable routing device, the first network terminal, and the electronic device is mutual independence without data transmission.

17. A power saving method for a portable routing device, the portable routing device is coupled with a first network terminal for building a third network terminal which allows an electronic device to access the first network terminal, the method comprising the following steps of:
R1: counting a duration time; and
R2: performing a corresponding controlling action in accordance with a predetermined factor;
wherein the duration time is a time span when the network traffic per unit time between the electronic device and the third network terminal is below a threshold value.

18. The power saving method of claim 17, wherein when the predetermined factor is the duration time above a first threshold value, the corresponding controlling action is to interrupt the data transmission between the portable routing device and the first network terminal.

19. The portable routing device of claim 17, wherein when the predetermined factor is the duration time above a second threshold value, the corresponding control ling action is to turn off the third network terminal.

20. The portable routing device of claim 17, wherein when the predetermined factor is the duration time above a second threshold value, the corresponding controlling action is to switch the portable routing device into a standby mode, indicating the relationship among the portable routing device, the first network terminal, and the electronic device is mutual independence without data transmission.
